(19) United States
(12) Patent Application Publication
(10) Pub. No.: US 2014/0168172 A1
(43) Pub. Date: Jun. 19, 2014

(54) CAPACITIVE DISK UNIT

(71) Applicants: Zachary Joseph Zeliff, TAIPEI (TW); Yueh Hua Li, Taipei (TW)

(72) Inventors: Zachary Joseph Zeliff, TAIPEI (TW); Yueh Hua Li, Taipei (TW)

(21) Appl. No.: 13/713,010

(22) Filed: Dec. 13, 2012

(51) Int. Cl. G06F 3/0354

(52) U.S. Cl. CPC G06F 3/03545
USPC 345/179

(57) ABSTRACT

Embodiments of a capacitive disk unit for a stylus for a capacitive touchscreen are disclosed. A conductive coupler has a flat proximal face and a socket for receiving a ball joint on its distal end. The distal portion of the socket may comprise a plurality of thin fingers that flex to capture the ball, forming notches between the fingers that are wide enough for the stylus shaft to pass into them, allowing the body of the stylus to be moved to a lower angle to the conductive coupler. Conductivity between the unit and the stylus is maintained continuously. If a larger diameter conductive surface is necessary, it may further comprise a disk and conductive layer, which may both be transparent. The conductive coupler may be molded of conductive polymer, and the disk may be overmolded using transparent polymer. Lack of metal parts reduces complexity, cost, and manufacturing defect risks.

The disclosure relates to styluses for use with a capacitive touchscreen, and more particularly to articulated styluses having a conductive disk unit for use with a capacitive touchscreen.

### DESCRIPTION OF THE RELATED ART

Styluses for use with capacitive touchscreens are increasingly popular among users of tablet computers and touchscreen smartphones for a variety of reasons, such as keeping the touchscreen clean from fingerprints and other smears. Capacitive touchscreens on these devices have certain inherent limitations, however, in that they are designed to require the sensing of a capacitive touch over a large area while also having sufficient capacitance in order to be identified by the hardware and firmware as a touch. This generally means a contact area that is roughly the size of a fingertip, and a capacitance large enough to be a substantial part of a human body.

A stylus tip must therefore mimic a human fingertip in size, and must somehow have enough capacitance electrically coupled to the stylus tip to meet the needs of the touchscreen hardware. Size is straightforward, but a large enough stylus tip, typically about 4.6 mm or larger in diameter, obscures the screen, making precision selection difficult. The capacitance of the human body can be electrically coupled to the stylus tip by providing a conductive path from the stylus tip through the handle to the hand of the user gripping the stylus, thus solving the second requirement.

U.S. patent application Ser. No. 13/237974, filed Nov. 9, 2011, is incorporated herein by reference in its entirety, and discloses embodiments of a stylus for capacitive touchscreens having a disk with a conductive surface that is electrically coupled to the stylus body, the disk being joined to the stylus handle by an articulated joint.

The inventors of the previous and present inventions created a stylus having a substantially transparent disk on an articulated joint to provide a precisely-sized non-obscuring stylus tip that remains flat against a touchscreen surface regardless of the angle at which the stylus body is being held or moved, across a wide angular range. Those previous embodiments used a transparent conducting disk, backed by a transparent polymer disk, having the conducting disk electrically coupled through a ball joint to the stylus handle, with a wear disk between the ball of the ball joint and the transparent conducting disk. The wear disk, made of a metal, prevented damage to the conducting disk by the ball of the ball joint while providing an electrically conductive path between the conductive disk and the ball of the ball joint. However, electrical coupling was intermittently lost when raising the stylus from the touchscreen because the ball of the ball joint would draw away from the wear disk. Also, the metal wear disk required careful preparation so that a sharp edge of the wear disk did not cut into the conductive disk; because of the resistivity of transparent conductors such as ITO, this type of damage changed the shape of the detected touch against the screen, and if the cut were around a substantial portion of the circumference of the metal wear disk, the damage could significantly reduce both the area over which capacitance was sensed and the amount of capacitance sensed, putting it below the threshold for which capacitive touchscreens are designed. Furthermore, the wear disk had a second potential damage mechanism in that when a wear disk was domed or dimpled or otherwise had a protrusion, it could force a portion of the conductive layer to protrude, resulting in increased wear of the conductive layer at the protrusion, ultimately leading to rapid degradation of electrical conductance as the conductive layer wore away.

The risk of damage, as well as the ordinary wear on the transparent conductive disk, meant that it was desirable for the capacitive disk units to be user-replaceable, and so a snap-on/snap-off socket was used. However, the physical design of the snap meant that the socket had to engage the ball of the ball joint above a great circle such that greater than 50% of the ball was below the snap. This restricted the angle that could be formed between the stylus body and the capacitive disk to about 40 degrees from vertical in any direction. As touchscreens have grown in size, this increasingly limits the user's freedom of movement when using a stylus to interact with a touchscreen.

Other stylus designs hold a transparent conductive member using an elastic coupler, or along an edge of the conductive member at a fixed angle. Other capacitive styluses are known in the art, most commonly using a conductive silicone rubber tip.

Improvements reducing the complexity and the chance of self-inflicted physical damage to the capacitive disk unit, and increasing the range of movement of the capacitive disk unit, are greatly desirable.

### BRIEF DESCRIPTION OF THE EMBODIMENTS

Embodiments are disclosed using a conductive polymer coupler to provide electrical conductance from a contacting surface of the conductive disk unit to the ball of the ball joint. By making the coupler of a conductive polymer, the metal wear disk of prior art designs can be eliminated. Embodiments are disclosed having a ball socket with fingers, which allows a wider range of angles between the stylus body and the contacting surface of the conductive disk unit.

### DESCRIPTION OF THE DRAWINGS

FIG. 1 is a perspective drawing of an embodiment of a capacitive disk unit having a coupler;

FIG. 2 is a cross-sectional view of a capacitive disk unit having a coupler;

FIG. 3 is a top view of an embodiment of a capacitive disk unit having a coupler;

FIG. 4 is a side view of an embodiment of a capacitive disk unit having a coupler;

FIG. 5 is a perspective drawing of an embodiment of a capacitive disk unit with a stylus coupled to it;

FIG. 6 is a cross-sectional view of a capacitive disk unit with a stylus coupled to it;

FIG. 7 is a top view of an embodiment of a capacitive disk unit with a stylus coupled to it;

FIG. 8 is a side view of an embodiment of a capacitive disk unit with a stylus coupled to it;

FIG. 9 is a perspective drawing of an embodiment of a capacitive disk unit for a high-resolution capacitive touchscreen with a stylus coupled to it;

FIG. 10 is a cross-sectional view of a capacitive disk unit for a high-resolution capacitive touchscreen;

FIG. 11 is a top view of an embodiment of a capacitive disk unit for a high-resolution capacitive touchscreen;

FIG. 12 is a side view of an embodiment of a capacitive disk unit for a high-resolution capacitive touchscreen;

FIG. 13 is a perspective drawing of an embodiment of a capacitive disk unit having a wear disk;

FIG. 14 is a cross-sectional view of a capacitive disk unit having a wear disk;

FIG. 15 is a top view of an embodiment of a capacitive disk unit having a wear disk;

FIG. 16 is a side view of an embodiment of a capacitive disk unit having a wear disk;

FIG. 17 is a cross-sectional view of parts other than the monolithic body for an embodiment of a capacitive disk unit having a wear disk;

FIG. 18 is a cross-sectional view of a monolithic body for an embodiment of a capacitive disk unit having a wear disk;

FIG. 19 is a cross-sectional view of an embodiment of a capacitive disk unit having a wear disk, coupled to a stylus;

FIG. 20 is a cross-sectional view of an embodiment of a capacitive disk unit having a coupler with a stylus coupled to it;

FIG. 21 is a perspective view of an embodiment of a capacitive disk unit;

FIG. 22 is a cross-sectional view of an embodiment of a capacitive disk unit;

FIG. 23 is a top view of an embodiment of a capacitive disk unit;

FIG. 24 is a side view of an embodiment of a capacitive disk unit coupled to a stylus;

FIG. 25 is a top view of an embodiment of a disk component;

FIG. 26 is a perspective view of an embodiment of a disk component;

FIG. 27 is a side view of an embodiment of a disk component;

FIG. 28 is a cross-sectional view of an embodiment of a disk component; and

FIG. 29 is a top view of an embodiment of a conductive layer.

### DETAILED DESCRIPTION

The following detailed description of embodiments of the invention references the accompanying drawings that form a part hereof, and in which are shown by way of illustration specific embodiments in which the invention may be practiced. The embodiments are described in sufficient detail to enable those skilled in the art to practice the invention, and it is to be understood that other embodiments may be utilized and that logical changes may be made without departing from the spirit and scope of the present invention. The detailed description is, therefore, not to be taken in a limiting sense, and the scope of the present invention is defined solely by the appended claims.

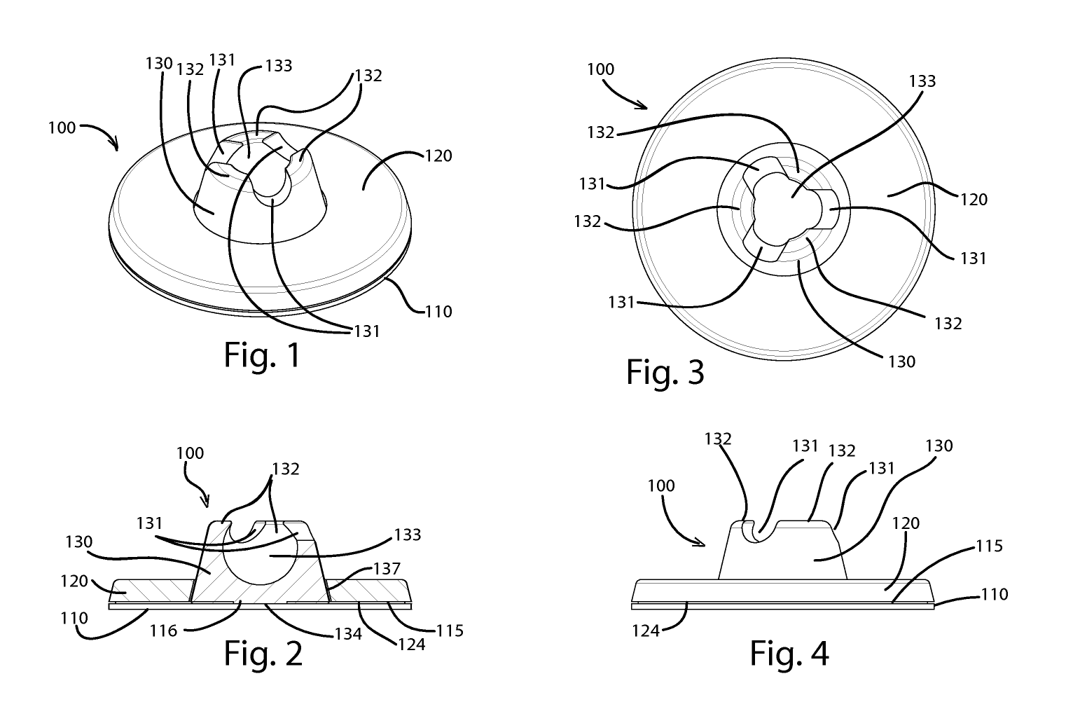

Please refer to FIG. 1, FIG. 2, FIG. 3, and FIG. 4, four views (perspective, cross-sectional, top, and side, respectively) of an embodiment of a capacitive disk unit. The embodiment of a capacitive disk unit 100 has a conductive layer 110, a disk 120, and a coupler 130.

The conductive layer 110 is conductive so that it can interact with a capacitive touchscreen of a typical smartphone or tablet computer, such as the Apple® iPhone® or iPad®. The conductive layer 110 serves to couple a capacitance to a larger area of a capacitive touchscreen, in order to meet the touch size requirements of a given capacitive touchscreen. The size of the conductive layer 110 is thus determined by the requirements of the capacitive touchscreen(s) on which the capacitive disk unit 100 is intended to be used; current devices typically use capacitive touchscreens designed to detect objects of about the size and capacitance of a human fingertip, leading to a diameter of about 4.6mm. The conductive layer 110 is substantially flat. The conductive layer 110 may optionally have the property of being transparent by manufacturing it with a transparent conductor, for example ITO or AZO. The conductive layer 110 is backed by both the disk 120 and the coupler 130. The conductive layer may be formed directly upon the disk 120 and coupler 130, or it may be formed separately and attached to the disk 120, or to the disk 120 and coupler 130, with an adhesive layer 115. When attached with adhesive, then either the adhesive must be conductive or the adhesive should be applied in a pattern such that the conductive layer 110 remains electrically coupled to the coupler 130. In FIG. 2, the adhesive layer 115 is shown as having a central hole 116 so that the coupler 130 may directly abut the conductive layer 110; for example, the adhesive may be laid out in an annular pattern on the disk 120, or on the disk 120 and the coupler 130.

The disk 120 may be made of any rigid material, and may be transparent. Some embodiments use a transparent polymer material for the disk 120. The disk 120 serves to protect the conductive layer 110 from damage that might otherwise be caused by overstressing the conductive layer 110, such as by bending the conductive layer 110 or nicking the edges of the conductive layer 110. The size of the disk 120 may be equal to or larger than the size of the conductive layer 110. The size and shape of the disk 120 is selected to conform to the size and shape of the conductive layer 110, which in turn is based upon the requirements of the electronic device for which the stylus and capacitive disk unit will be used; current devices typically use capacitive touchscreens designed to detect objects of about the size and capacitance of a human fingertip, leading to a diameter of about 4.6mm.

The coupler 130 has a socket 133 to receive a ball of a ball joint, the socket comprising a plurality of fingers 132, which define a plurality of notches 131; optionally, the coupler 130 may further have a slight protrusion on its proximal face 134 to press against the conductive layer 110, or the coupler's proximal face 134 may be substantially flat. In embodiments in which the coupler 130 has a protrusion, the protrusion increases the contact pressure between the coupler 130 and the conductive layer 110, thereby helping to ensure conductivity. Unlike uncontrolled convexity as a result of manufacturing defects in the prior art products, such a protrusion in the present invention can be designed in and carefully controlled in the design, forming, and assembly processes so that the resulting product does not cause premature wear of the conductive layer 110 of the capacitive disk unit 100. The notches 131 may optionally extend below an equator of the socket 133, whereas the fingers 132 extend above the equator of the socket 133 and serve to retain a ball of a ball joint in the socket 133. The coupler 130 is made of a conductive material; some embodiments use a conductive polymer for the coupler 130. Because the fingers 132 can be made thin enough to allow a conductive polymer to flex without fracturing, a ball of a ball joint can be snapped into and out of the socket 133 repeatedly. Although three notches 131 are shown in the example drawings, embodiments using two, three, four, and more notches have been considered during development; as the number of notches 131 increases, the amount of remaining material in the fingers 132 for effecting retention of the ball in the socket 133 necessarily decreases. Testing has found that three notches 131, defining three fingers 132, provides a good balance between the competing desires of a strong connection and smooth movement. The disk 120 may ride on the sides #### of the coupler 130 without being attached; or may be mechanically attached to the coupler 130 along a contact region 137 through friction or through the use of interlocking shapes such as grooves or scallops (for example, see the embodiments of FIG. 20 and FIG. 24 below); or may be bonded to the coupler 130 along the contact region 137 either chemically, or with adhesives, or during molding when appropriate materials (such as compatible polymers) are selected for both the disk 120 and the coupler 130 such that, for example, overmolding melts or bonds the two materials together.

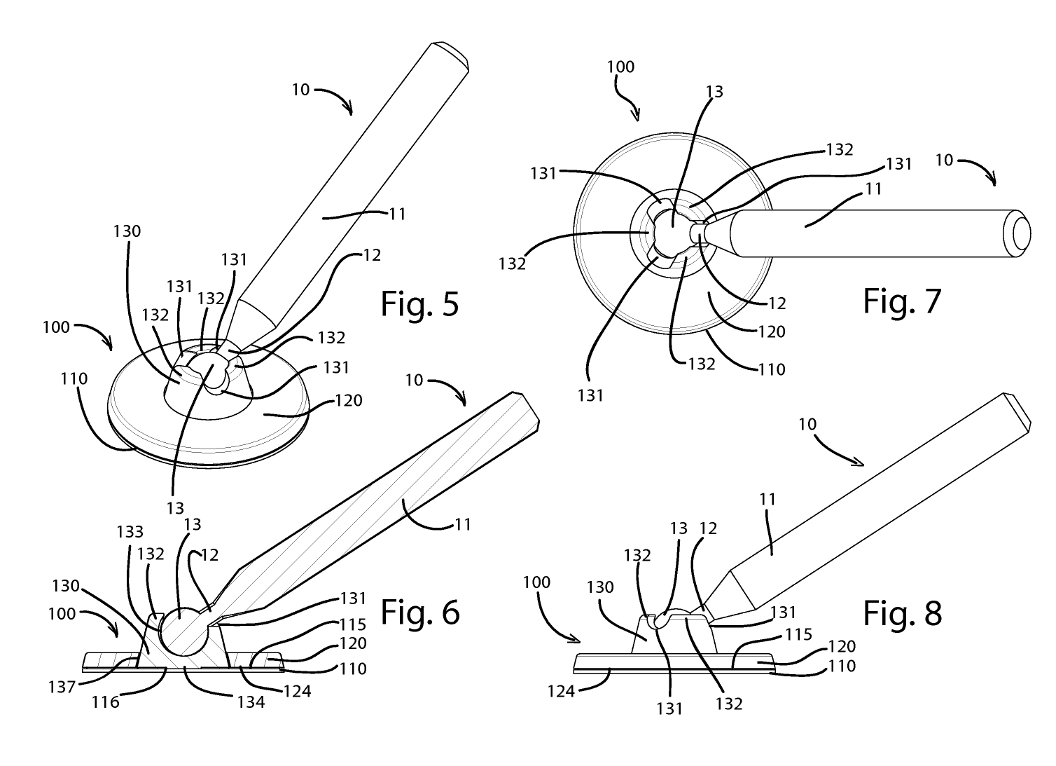

Referring to FIG. 5, FIG. 6, FIG. 7, and FIG. 8, four views (perspective, cross-sectional, top, and side respectively) of the same embodiment as in FIGS. 1-4 of a capacitive disk unit 100, shown here coupled to a stylus 10. The stylus 10 comprises a handle 11, a shaft 12, and a ball 13. The ball 13 fits within the socket 133 of the coupler 130, thus forming a ball joint. The ball 13, shaft 12, and handle 11 may be made of a conductive material such as a metal or a conductive polymer. The shaft 12 is electrically coupled to the ball 13. The shaft 12 may be directly connected to the handle 11 thus forming an electrical connection therewith, or the shaft 12 may be isolated from the handle 11 and be coupled to electronics (not shown), which may optionally in turn be coupled to the handle 11.

Referring to FIG. 6 and FIG. 8 in particular, the shaft 12 of the stylus is shown nestled in one of the notches 131 of the coupler 130. This allows the handle to be held at a closer angle to the conductive layer 110 of the capacitive disk unit 100 than with prior-art capacitive disks. This allows a user more freedom of movement and position when using the stylus 10, for example when drawing or writing on a large-screen tablet computer.

As seen in FIG. 3 and FIG. 7 the fingers 132 have a wedge-shaped aspect when viewed from above. The design allows the shaft 12 of the stylus 10 to engage a notch 131 no matter what angle relative to the capacitive disk unit 100 at which the shaft 12 is moved; due to the small sizes of the fingers 132, the shaft 12 readily slips into a nearby notch 131 regardless of the angle and pressure used. In use, with the capacitive disk unit 100 pressed flat against a surface such as a capacitive touchscreen (not shown), this wedging causes the capacitive disk unit 100 to rotate such that the shaft 12 moves into a notch 131 as the handle moves away from an orthogonal position. In use, pressure by the ball 13 of the stylus 10 against the bottom of the socket 133 elastically deforms the coupler 130, pressing its proximal face 134 against the capacitive layer 110, thus helping to ensure that electrical conductivity is maintained. The bottom of the socket 133 is closed, which limits the force that can be transmitted through the shaft 12 and ball 13 against the conductive layer 110, and helps prevent wear and damage to the conductive layer 110 by spreading the force over a wider area.

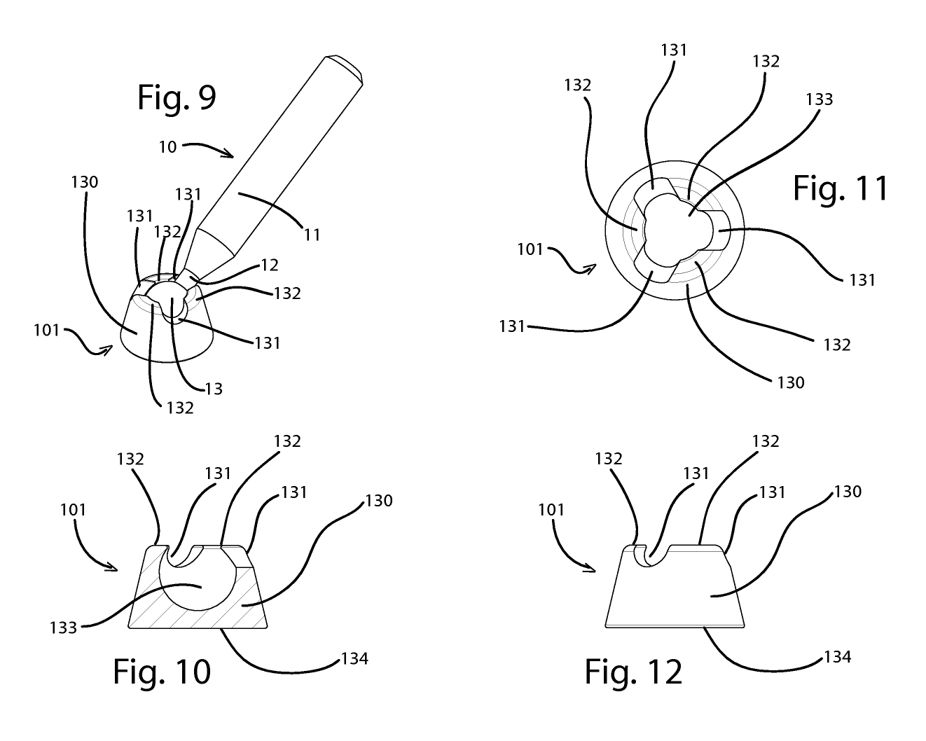

Please refer now to FIG. 9, FIG. 10, FIG. 11, and FIG. 12, four views (perspective, cross-sectional, top, and side respectively) of an embodiment of a capacitive disk unit consisting of a monolithic coupler. FIG. 9 also shows the capacitive disk unit 101, which in this embodiment is the coupler 130, coupled to a stylus 10. High-resolution touchscreens exist for some electronic devices and may become more prevalent; the necessary diameter of a detectable touch for these is smaller, and indeed the electronics can be designed to require a small enough touch that the larger area provided by having a disk 120 and conductive layer 110 are unnecessary. However, a large capacitance is still desirable to weed out noise. The coupler 130 may be used by itself on the end of a stylus, without a conductive layer 110 or a disk 120. These figures show a coupler 130 with a substantially flat proximal face 134 as the conductive surface that interacts with a capacitive touchscreen's capacitive flux. The coupler 130 further has a ball joint socket comprising fingers 132, notches 131, and substantially spherical socket 133 for coupling to a ball 13 as seen in FIG. 9.

The coupler 130 is made of a conductive polymer, and so serves to electrically couple a conductive surface that interacts with the touchscreen to the ball joint 13, whether that conductive surface is a conductive layer 110 electrically coupled to a coupler 130, as in some embodiments, or a proximal face 134 of the coupler 130 itself as in other embodiments. The ball joint 13 is in turn electrically coupled to the shaft 12, which in turn may be electrically coupled to the handle 11 when used with passive styluses, or may be electrically coupled to active electronics (not shown). When a passive stylus is held by a human hand, the human body is thus electrically coupled to the conductive surface that is interacting with the touchscreen's capacitive flux, thereby providing sufficient capacitance to interact with high-resolution capacitive touchscreens.

Please refer now to FIG. 20, which shows a cross-section of an embodiment of a capacitive disk unit with a stylus. The capacitive disk unit 300 comprises a coupler 330 and disk 320. In this embodiment, the coupler 330 further comprises a step in the contact region 337 between the disk 320 and the coupler 330, and the disk 320 further comprises a matching step, which serves to increase the contact area between the disk 320 and the coupler 330. This variation in the shape of the contact region 337 serves to provide increased surface area for bonding between the two materials, and may instead or in addition be shaped with ridges, grooves, scallops, dimples, textured surfaces, or other variations, to interlock and/or create mechanical interference between the two materials so as to prevent separation. Although FIG. 20 shows a step in the contact region 337, other shapes are well known in the art of plastic injection molding and may be used instead or in addition.

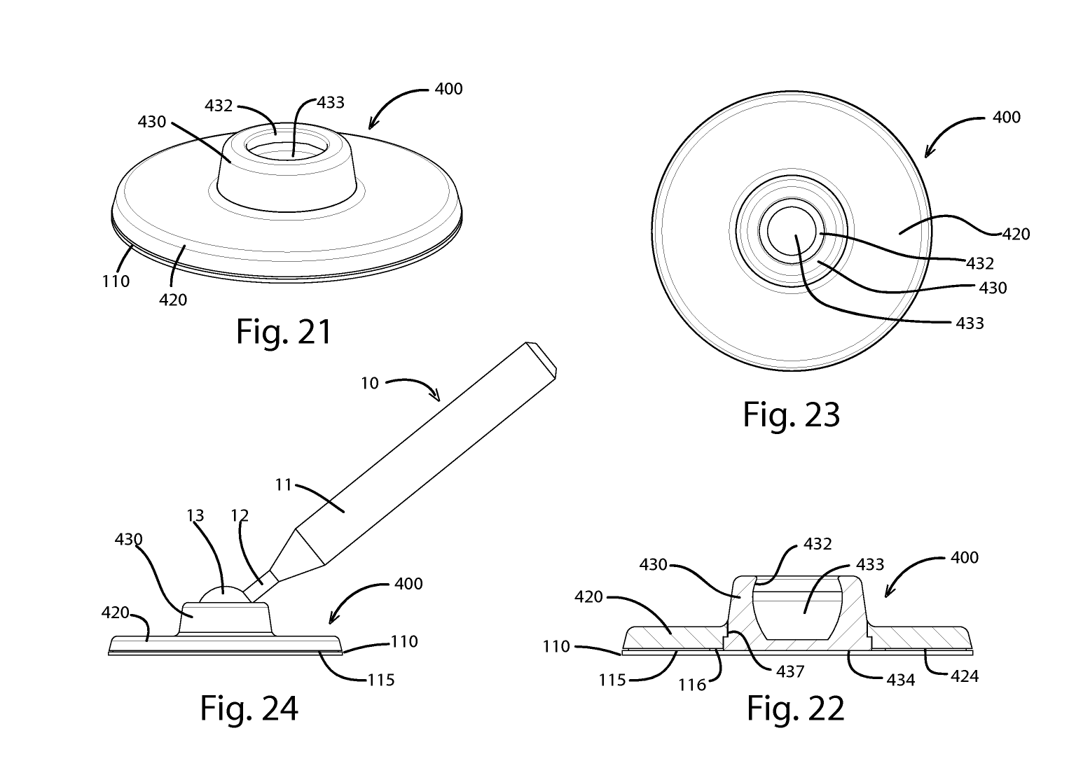

Refer now to FIG. 21, FIG. 22, FIG. 23, and FIG. 24, which are four views (perspective, cross-sectional side, top, and side with stylus view respectively) of an embodiment of a capacitive disk unit. The capacitive disk unit 400 has a conductive layer 110, a disk 420, and a coupler 430. The disk's proximal face 424 and coupler's proximal face 434 may be substantially coplanar, or the proximal face 434 of the coupler 430 may protrude slightly beyond the proximal face 424 of the disk 420 to increase contact with the conductive layer 110. The contact region 437 between the disk 420 and coupler 430 may optionally be physically shaped to help prevent separation of the two components, as shown in the figures of this embodiment, or the disk 420 may ride loosely upon the coupler 430 as discussed in previous embodiments, or the disk 420 may be attached to the coupler 430 through overmolding, adhesive or chemical bonding, or other means generally known. The disk 420 may optionally be of a transparent material such as a transparent polymer. The coupler 430 is conductive; the coupler 430 may be made of a conductive polymer. The coupler 430 is electrically coupled to the conductive layer 110. The conductive layer 110 may be formed directly upon the proximal faces 424,434 of the disk 420 and coupler 430 or may be adhered to the disk 420, or to the disk 420 and coupler 430, by means of an adhesive layer 115. The conductive layer 110 may be formed of a transparent conductive material, for example ITO or AZO. The adhesive layer 115 may be of a conductive adhesive or a nonconductive adhesive; if the adhesive layer 115 is of a nonconductive adhesive, then the adhesive layer 115 must have a hole 116 through which the coupler 430 may electrically couple to the conductive layer 110; the adhesive layer 115 and hole 116 may, for example, be substantially annular in layout. The coupler 430 has a socket 433 sized to fit a ball 13 of a stylus 10, thus forming a ball joint. The rim 432 of the socket 433 is of a smaller diameter than the ball 13, thereby retaining the ball 13 when the ball 13 is snapped into the socket 433.

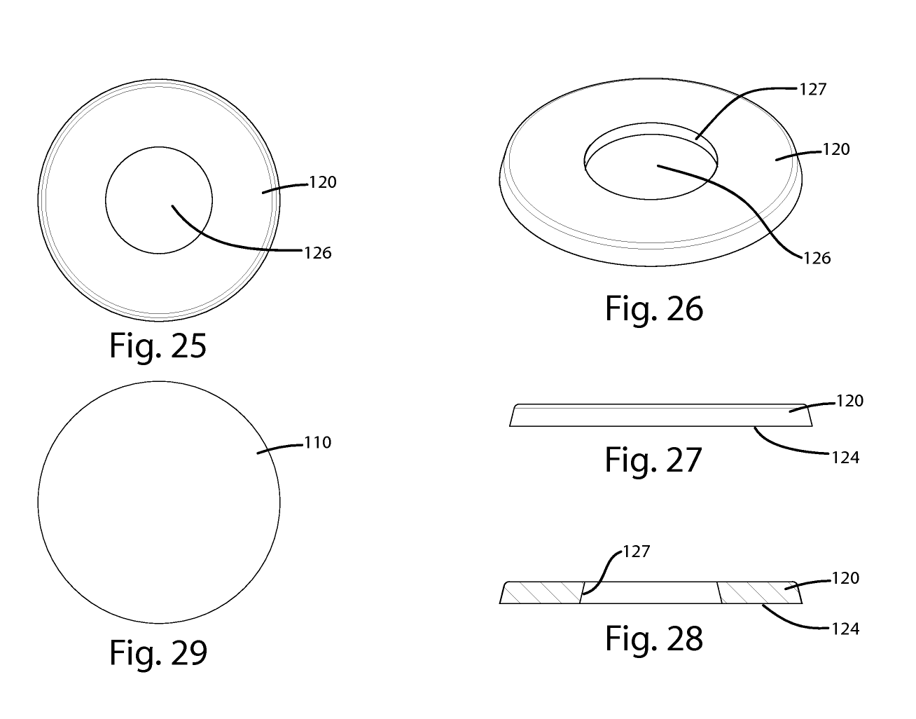

FIG. 25, FIG. 26, FIG. 27, and FIG. 28 are top, perspective, side, and cross-sectional views of a disk 120 used by some embodiments. The disk 120 has a central hole 126 that fits around a coupler embodiment. The contact surface 127 of the disk 120 is shaped or molded to substantially match the contact surface of the embodiment of the coupler for which the particular embodiment of the disk 120 is to be used. The proximal face 124 of the disk 120 may have a conductive layer formed directly upon it or attached by conventional means such as adhesive.

FIG. 29 shows a top view of a conductive layer 110. The conductive layer 110 is substantially flat and is electrically conductive. The conductive layer 110 may optionally be transparent, for example when made with ITO, AZO, or a similar transparent conductive material, or may be translucent or opaque if made with a metal foil, conductive polymer, or other conductive material.

As explained in the previous embodiments, using a conductive polymer as the material for the coupler 130 has several advantages over the prior art. First, conductivity is maintained no matter whether the stylus is being pressed against a surface or not, because no matter whether the stylus is being lifted (in embodiments using a coupler, resulting in the conductive disk unit 101 hanging from the ball 13 of the stylus 10, with the resultant contact between the ball 13 of the ball joint and the socket 133 being at an upper interior surface of the socket 133 such as at the fingers 132) or the stylus is being pressed, the ball 13 of the ball joint will always be in contact with conductive material of the socket 133 of the coupler 130 in embodiments of the present invention. Second, manufacturing is simplified, because no conductive metal wear disk is necessary to protect the thin and fragile conductive layer 110, reducing parts complexity. Third, the metal wear disk of the prior art had to be made carefully so that no sharp edges could result in cutting of the conductive layer 110; if a sharp edge damaged the conductive layer 110, because of the resistivity of the ITO used for the transparent conductive layer, overall capacitive coupling could be reduced and the touch sensed by a capacitive touchscreen could become reduced and distorted in size and shape.

The shape of the improved coupler 130 also has significant advantages over the prior art. In addition to allowing the stylus body to be moved through a broader angular range relative to the face of the capacitive disk unit by virtue of allowing the shaft 12 of a stylus 10 to fit into a notch 131, the fingered design allows more brittle polymers, such as conductive polymers, to be used; the fingers 132 allow the polymer to flex more than the previous full-circumference-capture socket design, so although the conductive polymer is more brittle than the polymers used in prior-art implementations, the socket 133 nevertheless does not fracture. The fingers 132 also retain the ball over a larger effective volume, resulting in a more secure connection and helping to maintain electrical conductivity at all times.

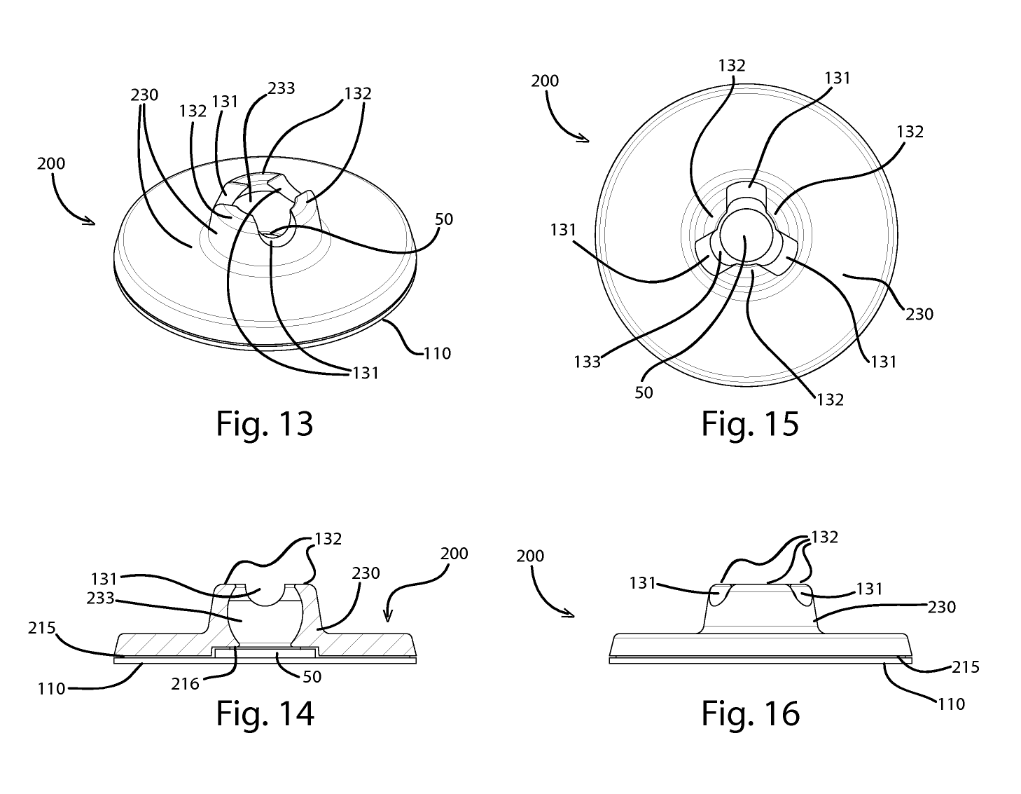

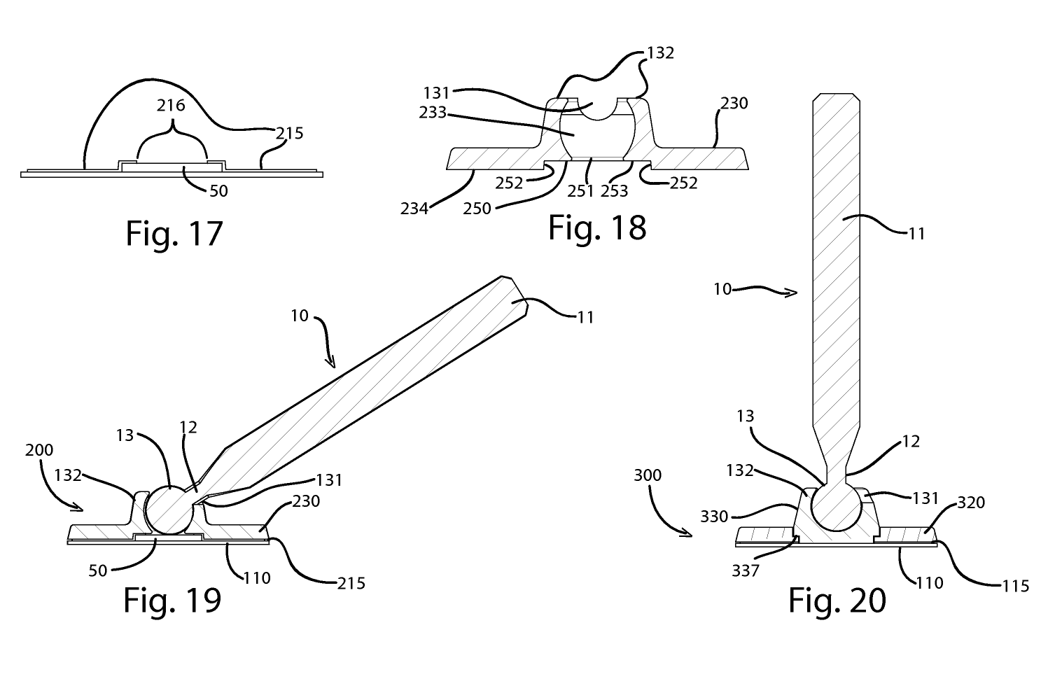

FIG. 13, FIG. 14, FIG. 15, and FIG. 16 are drawings (in perspective, cross-section, top view, and side view respectively) of an embodiment of a capacitive disk unit having a monolithic body. Additionally, for clarity, FIG. 18 shows the monolithic body 230 alone in cross-section. FIG. 17 shows a cross-sectional view of parts other than the monolithic body 230 for the embodiment of a capacitive disk unit 200 having a monolithic body 230. FIG. 19 shows an embodiment of a capacitive disk unit 200 coupled to a stylus. The capacitive disk unit 200 comprises a monolithic body 230 having a socket 233 for a ball joint intersecting a hollow 250, thus allowing a ball 13 of a ball joint to contact a wear disk 50 inserted into the hollow 250 molded into the underside of the monolithic body 230. The top of the socket 233 has a plurality of fingers 132 defining a plurality of notches 131. An adhesive layer 215 bonds a conductive layer 110 to the proximal face 234 of the monolithic body 230. A hole 216 in the adhesive layer 215, said hole 216 being larger than the opening 251 in the bottom of the ball socket 233, prevents the adhesive of the adhesive layer 215 from gumming up the ball joint and also allows the conductive layer 110 to remain in contact with and hence electrically coupled to the wear disk 50. The wear disk 50 protects the relatively fragile conductive layer 110 from being torn or worn away by the motion of the ball 13 in the socket 233 while allowing the conductive layer 110 to be electrically coupled to the ball 13, which is electrically coupled to the shaft 12. The ball socket 233 is in the form of a substantially spherical intersection with the monolithic body 230, as contrasted with the prior art being roughly hemispherical at the socket and open toward the proximal face 234. Because the ball socket 233 is spherical, it provides support to the ball 13 of the ball joint when the stylus 10 is pressed against a surface; this support helps to prevent damage to the conductive layer 110 from the ball 13 transmitting the full user-applied force to the wear disk 50, and through that to the conductive layer 110. Instead, in the present embodiment, force is transmitted through the ball 13 to the monolithic body 230 as well as the wear disk 50, thus limiting the differences in force applied between an edge of the conductive layer 110 and the center of the conductive layer 110 directly below the wear disk 50. The shaft 12 may electrically couple the conductive layer 110 to the handle 11, and through that to the user, in the case of a passive stylus; or to electronic circuitry (not shown) in the case of an active stylus, or to both, to provide sufficient capacitance for the capacitive touchscreen (not shown) with which the stylus is used to function.

FIG. 17 shows the cross-section view of FIG. 14, but with the monolithic body 230 removed so that details of the adhesive layer 215 can be seen more readily. At manufacturing time, the conductive layer 110 is laid flat, the wear disk 50 is placed on top of the conductive layer 110, and the adhesive layer 215 is placed over the tops of both the wear disk 50 and conductive layer 110. This helps to hold the wear disk 50 against the conductive layer 110, thus helping to maintain conductivity between them. The wear disk 50 fits within the hollow 250 in the monolithic body 230, and the ball 13 of the stylus body 10 is held against it. The hollow 250 may be shaped to fit the wear disk 50 and adhesive layer 215 closely, or may be of a more open size or more arbitrary shape. The hollow 250 intersects the socket 233 to form an opening 251 through which the ball 13 of the ball joint, when inserted into the socket 233, contacts the wear disk 50. The wall 252 of the hollow 250 may optionally be tapered such that the hollow 250 is wider where it intersects the proximal face 234 than at its top 253 where it intersects the socket 233; this helps to center the wear disk 50 during assembly of the capacitive disk unit 200, particularly when the hollow 250 is shaped to fit the wear disk 50 and adhesive layer 215 closely.

While the disclosure has been described by way of examples and in terms of embodiments, it is to be understood that the disclosure is not limited thereto. On the contrary, it is intended to cover various modifications and similar arrangements (as would be apparent to those skilled in the art). Therefore, the scope of the appended claims should be accorded the broadest interpretation so as to encompass all such modifications and similar arrangements.

We claim:

1. A capacitive disk unit, comprising:
a coupler, said coupler comprising:
a proximal face, and
a socket, the socket comprising a plurality of fingers;
wherein the coupler is conductive.

2. The capacitive disk unit of claim 1, further comprising:
a disk, a proximal face of the disk being substantially coplanar with the proximal face of the coupler.

3. The capacitive disk unit of claim 2, where the disk is transparent.

4. The capacitive disk unit of claim 2 further comprising a conductive layer, wherein the conductive layer is electrically coupled to the coupler.

5. The capacitive disk unit of claim 4, wherein the proximal face of the coupler is a convex spherical cap.

6. The capacitive disk unit of claim 4, further comprising an adhesive layer, the adhesive layer bonding the conductive layer to the disk.

7. The capacitive disk unit of claim 1, wherein the coupler is formed of a conductive polymer.

8. The capacitive disk unit of claim 1, wherein the number of fingers in the plurality of fingers is 3.

9. The capacitive disk unit of claim 1, wherein the socket is substantially spherical.

10. The capacitive disk unit of claim 1, further comprising a stylus,
the stylus comprising a handle, a shaft, and a ball, the ball being electrically coupled to the shaft, the shaft being electrically coupled to the handle, the ball being electrically conductive, the shaft being electrically conductive, the handle being electrically conductive;
wherein the ball is received in the socket to form a ball joint,
wherein the plurality of fingers define a plurality of notches, and
wherein each notch of the plurality of notches has a width sufficient to admit the shaft.

11. A capacitive disk unit, comprising:
a coupler, said coupler comprising:
a proximal face, and
a socket;
wherein the coupler is conductive.

12. The capacitive disk unit of claim 11, wherein the socket is substantially spherical.

13. The capacitive disk unit of claim 11, further comprising:
a disk, a proximal face of the disk being substantially coplanar with the proximal face of the coupler.

14. The capacitive disk unit of claim 13, where the disk is transparent.

15. The capacitive disk unit of claim 13, further comprising a conductive layer, wherein the conductive layer is electrically coupled to the coupler.

16. The capacitive disk unit of claim 15, wherein the proximal face of the coupler is a convex spherical cap.

17. The capacitive disk unit of claim 1, wherein the coupler is formed of a conductive polymer.

18. A capacitive disk unit, comprising:
a monolithic body comprising:
a proximal face,
a hollow formed in the proximal face, and
a socket, the socket comprising a plurality of fingers at a distal end of the monolithic body, the socket intersecting the hollow.

19. The capacitive disk unit of claim 17, wherein the socket is substantially spherical.

20. The capacitive disk unit of claim 17, further comprising a wear disk,
an adhesive layer, and a conductive layer,
wherein the adhesive layer bonds the conductive layer to the proximal face of the monolithic body, and
wherein the wear disk is positioned such that it is located in the hollow between the conductive layer and the monolithic body.

21. The capacitive disk unit of claim 19, where the adhesive layer is not between the wear disk and the conductive layer.
